(19) United States
(12) Patent Application Publication
(10) Pub. No.: US 2009/0092005 A1
(43) Pub. Date: Apr. 9, 2009

(54) CONTROLLING SEISMIC SOURCE ELEMENTS BASED ON DETERMINING A THREE-DIMENSIONAL GEOMETRY OF THE SEISMIC SOURCE ELEMENTS

(76) Inventors: NICOLAS GOUJON, Oslo (NO); LUREN YANG, Oslo (NO); ASLAUG STROEMMEN MELBOE, Bekkestua (NO)

Correspondence Address: WesternGeco L.L.C.;Jeffrey E. Griffin, 10001 Richmond Avenue, HOUSTON, TX, 77042-4299, US

(21) Appl. No.: 12/169,401

(22) Filed: Jul. 8, 2008

Related U.S. Application Data
(60) Provisional application No. 60/978,279, filed on Oct. 8, 2007.

(51) Int. Cl. G01V 1/38

(52) U.S. Cl. 367/19

(57) ABSTRACT

To control a seismic source having plural seismic source elements, a three-dimensional geometric shape of the plural seismic source elements is determined. Timings of activation of the plural seismic source elements is adjusted according to the determined three-dimensional geometric shape.

### TECHNICAL FIELD

The invention relates generally to controlling a seismic source having plural seismic source elements according to a determined three-dimensional geometry of the plural seismic source elements.

### BACKGROUND

This application claims the benefit under 35 U.S.C. §119(e) to U.S. Provisional Patent Application Ser. No. 60/978,279, having the same title, which was filed on Oct. 8, 2007, and is hereby incorporated by reference in its entirety.

Seismic surveying is used for identifying subterranean elements, such as hydrocarbon reservoirs, fresh water aquifers, gas injection reservoirs, and so forth. In performing seismic surveying, seismic sources are placed at various locations above an earth surface or sea floor, with the seismic sources activated to generate seismic waves directed into the subterranean structure. Examples of seismic sources include explosives, air guns, or other sources that generate seismic waves. In a marine seismic surveying operation, the seismic sources can be towed through water.

The seismic waves generated by a seismic source travel into the subterranean structure, with a portion of the seismic waves reflected back to the surface for receipt by seismic receivers (e.g., geophones, hydrophones, etc.). These seismic receivers produce signals that represent detected seismic waves. Signals from seismic receivers are processed to yield information about the content and characteristic of the subterranean structure.

A seismic source (also referred to as a “seismic source array”) typically has an array of seismic source elements (e.g., air guns, vibrators, etc.) that emit seismic waves for seismic surveying. Typically, an array of seismic source elements is not a rigid structure, but rather, the seismic source elements are linked together by non-rigid interconnecting members, such as chains, ropes, or cables. The marine seismic source elements are towed at a certain depth in a body of water.

Due to the non-rigid arrangement of the array of seismic source elements, instability of the source array geometric shape can occur. For example, sea waves can cause instability of the array geometry, which can cause variation in source signature from shot to shot during a seismic surveying operation. In rough seas, the array will, to some extent, follow the shape of the sea surface, such that the seismic source elements will have varying shapes from shot to shot. The variation can cause perturbation in a far-field gun signature.

### SUMMARY

In general, according to an embodiment, a method of controlling a seismic source having plural seismic source elements includes determining a three-dimensional geometry of the plural seismic source elements. Timings of the activation of the plural seismic source elements are adjusted according to the determined three-dimensional geometry.

Other or alternative features will become apparent from the following description, from the drawings, and from the claims.

### BRIEF DESCRIPTION OF THE DRAWINGS

FIG. 1 illustrates a marine arrangement that includes a seismic source array and seismic receivers to collect seismic data in response to signals generated by the seismic source array.

FIG. 2 shows an array of seismic source elements in an example seismic source array.

FIGS. 3A-3B are schematic diagrams of example optical mechanisms for measuring a three-dimensional geometric shape of an array of seismic source elements.

FIG. 4 is a block diagram of seismic source elements and a floater, along with associated depth sensors and global positioning system (GPS) receivers.

FIG. 5 is a flow diagram of a process of controlling output of a seismic source array, according to a determined geometric shape of the array of seismic source elements.

FIG. 6 is a block diagram of a computer including control software for controlling output of the seismic source array, according to an embodiment.

FIG. 7 illustrates a vector representing a direction to which a seismic source array is focused, along with a distance between a seismic source element of the seismic source array and a plane perpendicular to the vector.

### DETAILED DESCRIPTION

In the following description, numerous details are set forth to provide an understanding of the present invention. However, it will be understood by those skilled in the art that the present invention may be practiced without these details and that numerous variations or modifications from the described embodiments are possible.

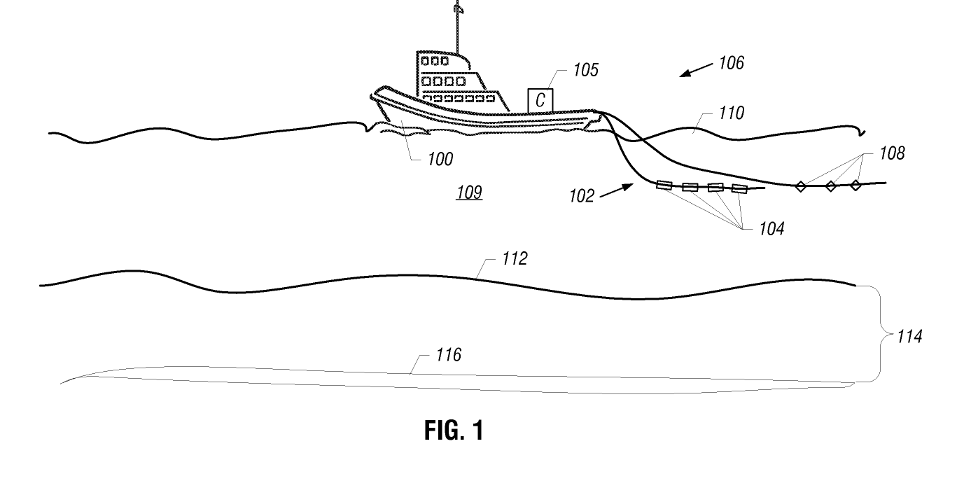

FIG. 1 illustrates a sea vessel 100 that is used to tow a seismic source array 102 having four illustrated seismic source elements 104, and a streamer 106 of seismic receivers 108. The seismic source array 102 and streamer 106 of seismic receivers 108 are towed in a body of water 109 beneath a sea surface 110. Although the seismic source array 102 and the streamer 106 of seismic receivers are depicted as being towed by one sea vessel 100, it is noted that the streamer 106 of seismic receivers and seismic source array 102 can be towed by different sea vessels. Moreover, each sea vessel can tow multiple seismic source arrays and/or multiple streamers of seismic receivers.

The seismic source array 102 and seismic receivers 108 are used to perform a subterranean survey of a subterranean structure 114 below a sea floor 112. The seismic source array 102 produces seismic signals that are propagated into the body of water 109 and into the subterranean structure 114. As examples, the seismic source elements can include air guns, air gun arrays, explosives, or other acoustic wave generators. The emitted seismic signals are reflected from elements (e.g., layers) in the subterranean structure 114, including a resistive body 116 that can be any one of a hydrocarbon-containing reservoir, a fresh water aquifer, a gas injection zone, and so forth. Signals reflected from the resistive body 116 are propagated upwardly toward the seismic receivers 108 for detection by the receivers. Measurement data is collected by the receivers 108, which can store the measurement data and/or transmit the measurement data back to a control system.

The seismic source array 102 is coupled to a controller 105 on the sea vessel 105. The controller 105 is used to control activation of the seismic source elements 104 in the seismic source array 102.

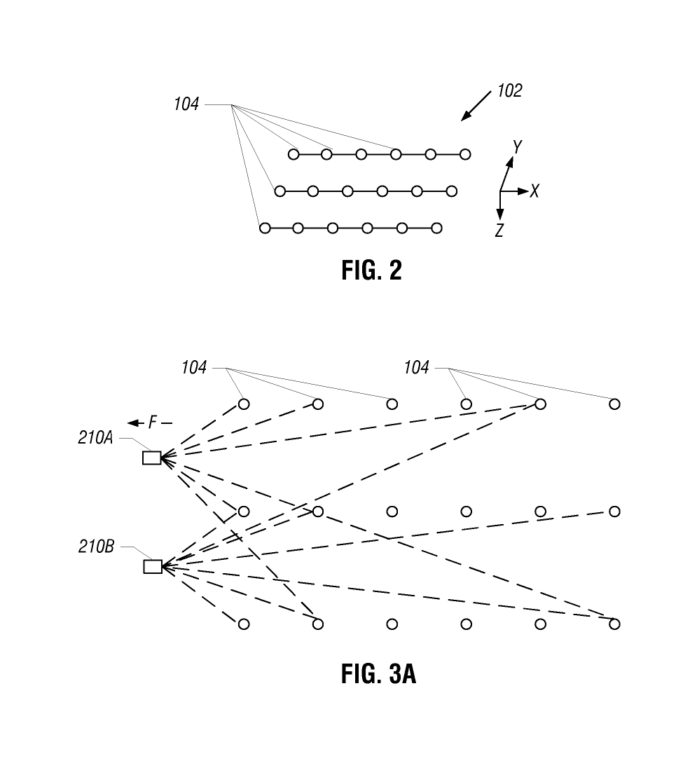

FIG. 2 shows an example seismic source array 102, which is made up of an array of seismic source elements 104 (e.g., air guns, explosives, or other acoustic generators). In the example of FIG. 2, the array is a 3×6 array of seismic source elements, although in other examples, arrays of other sizes can be provided. Also, in different implementations, instead of providing the seismic source elements in a generally rectangular array as depicted in FIG. 2, a collection of plural seismic source elements can have other arrangements. In the ensuing discussion, reference is made to an array of seismic elements—however, it is noted that techniques according to some embodiments can also be applied to other collections of seismic elements.

The seismic source elements 104 are interconnected by non-rigid connecting structures, such as chains, ropes, cables, and so forth. Due to the non-rigid arrangement of the array of seismic source elements 104, the array is subject to varying geometric shapes due to the sea environment, including sea surface waves, currents, and so forth. Also, instability of the geometric shape of the seismic source array can be due to sudden changes in vessel steering or due to source steering (e.g., winch steerable source array that pulls the source array to the side at the front of the array, which may introduce a mismatch between front and back of the array for a short period of time).

During a seismic surveying operation, it is desired that the variation in the source signature from shot to shot is small. However, under certain conditions, such as rough seas (which can be due to rough weather conditions), the desired small variation from shot to shot may not be achievable, since the array of seismic source elements 104 can be geometrically distorted differently by the sea environment between shots. The instability of the source array geometry leads to deviation from a target source signature of the seismic source array 102. The instability of the seismic source array geometry includes three-dimensional instability, where the geometric shape of the array of seismic source elements can be distorted in three dimensions (along the x, y, z coordinates).

In some implementations, the emitted signal from a seismic source array is focused vertically, such that in the far field, a seismic receiver or a reflector in the subterranean structure will have signals from all of the different seismic source elements arriving at generally the same time. If the geometry of the seismic source array deviates from the target nominal geometry of the array, then the emitted signals from the seismic source elements will no longer be focused toward the vertical direction. This can lead to perturbation in the far-field gun source signal signature.

Note that in other implementations, the signals emitted from the seismic source elements of a seismic source array can be focused toward a non-vertical direction, rather than the vertical direction.

To account for deviations in the geometric shape of an array of seismic source elements from a target nominal geometry, control of the seismic source elements in the array can be based on a determined (measured) three-dimensional geometric shape of the seismic source elements. The geometric shape of the array of seismic source elements is measured before each shot (where “shot” refers to activation of the seismic source). Based on the measured geometric shape of the array, the timing of each of the seismic source elements in the array can be calculated (such as by the controller 105) to reduce or minimize deviation from a desired source signature. The timing that is calculated can include a time shift from a corresponding target firing time for each of the seismic source elements. The seismic source elements are then activated, under control of the controller 105 (FIG. 1) according to the calculated timing for each of the seismic source elements.

By adaptively tuning the relative activation times of the seismic source elements according to the measured three-dimensional geometric shape of the source elements of the array, source signature deviation can be limited. Note that the shifting of the activation times according to the calculated timings is used to counteract the variation of the source array geometry. In this manner, repeatability of the signals emitted by the source array from shot to shot can be enhanced. Note that techniques according to some embodiments can also be applied to cases where the source signature is intended to be variable.

There is a small time delay between positioning of the seismic source elements (to measure the geometry of the array) and activation of the seismic source elements, which may cause a small error in computing the timings of the seismic source elements. In many cases, this error may be insignificant as the array geometry change is relatively slow and the time delay between the positioning and the source activation is relatively small. Note that measuring the geometry of the array of seismic source elements can be performed multiple times before source activation to predict correct positioning at the firing time by extrapolation using a linear or higher-order function.

To measure the three-dimensional geometric shape of an array of seismic source elements, various techniques can be employed. One such technique involves using an optical mechanism that uses optical devices associated with the seismic source elements to determine the three-dimensional shape of the array. In one example, the optical mechanism includes light sources, such as laser sources, that direct focused beams of light onto the seismic source elements of the array, which may have reflectors on outer surfaces of the seismic source elements to reflect the light from the light sources. The reflectors can be painted onto the seismic source elements, for example.

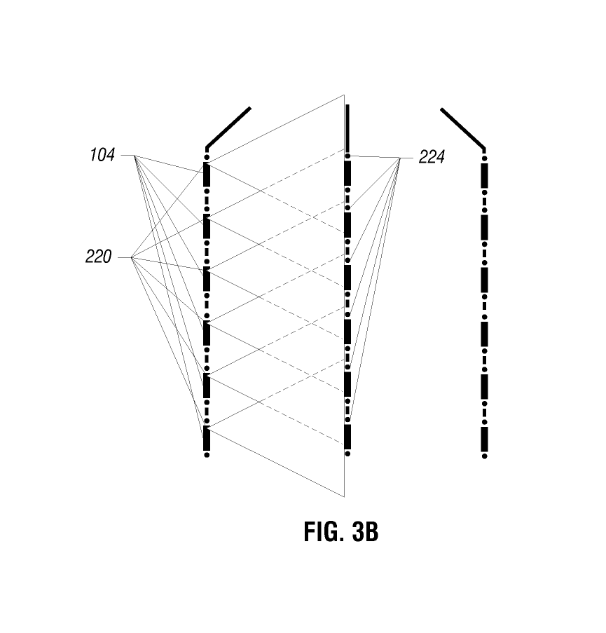

An example arrangement is depicted in FIG. 3A, which includes optical devices 210A, 210B that include light sources that direct focused beams of light (indicated by dashed lines) onto source elements 104. The light beams are reflected from the source elements and detected by light detectors in the optical devices 210A, 210B. Based on the emitted and reflected light, the inline distances d₁ (inline with the direction of movement of the seismic source as towed by the sea vessel) between seismic source elements 104 can be determined. Also, a cross-line second distance d₂ (cross-line or perpendicular to the direction of movement) between seismic elements 104. Although not depicted in FIG. 3A, another optical device can be provided such that three light sources are employed, which allows for determination of the elevation (depth) of each seismic source element 104 in the body of water 109. The depth of each seismic source element 104 extends along a direction that is perpendicular to the directions of d₁ and d₂. Alternatively, instead of using a third light source, depth sensors can be used to determine the elevation of each seismic source element. More details regarding optical mechanisms for determining a three-dimensional geometric shape of an array of seismic source elements is described in U.S. Ser. No. 11/456,059, entitled “Optical Methods and Systems in Marine Seismic Surveying,” filed Jul. 6, 2006, which is hereby incorporated by reference.

Instead of using the optical mechanism discussed above, a different mechanism can use acoustic ranging to determine the geometric shape of the seismic source elements of an array. Acoustic ranging involves the use of acoustic transmitters and acoustic receivers, where the acoustic transmitters are used to emit acoustic signals that are reflected from the seismic source elements in response to the emitted acoustic signals.

FIG. 3B shows an alternative embodiment that uses light sources 220 and cameras 224 to determine a three-dimensional geometric shape of an array of seismic source elements 104. The cameras 224 record images based on light from the light sources. Thus, the cameras 224 are recording primarily direct light, not reflected light. Each seismic source element 104 can be associated with a light source and a camera.

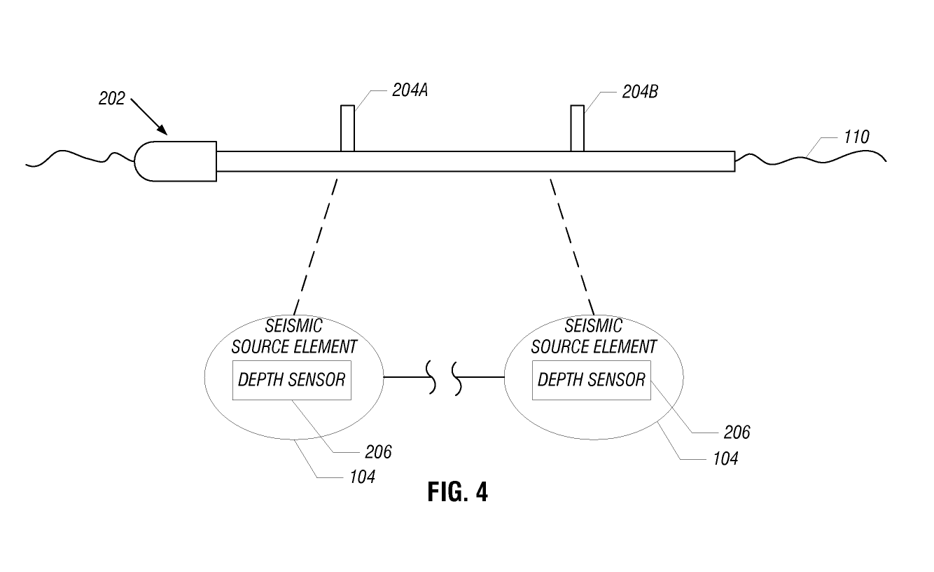

FIG. 4 shows an example embodiment that uses a global positioning system (GPS) receivers 204A, 204B and depth sensors 206 associated with seismic source elements to determine the depth (elevation) of the seismic source elements. The GPS receivers 204A, 204B and depth sensors 206 can be used in combination with the optical mechanism or acoustic ranging mechanism discussed above, or alternatively, the GPS receivers 204A, 204B and depth sensors 206 can be used without the optical or acoustic ranging mechanism (as discussed in connection with an alternative embodiment discussed further below).

As depicted in FIG. 4, seismic source elements 104 of an array can be coupled to a float 202 at the sea surface 110, where one example of the float 202 is a buoy. In the example depicted, the buoy 202 includes the GPS receivers 204A, 204B that can be used for measuring the elevation of the buoy 202. Note that the buoy 202 follows the shape of the sea surface 110. Moreover, each seismic source element 104 can include a corresponding depth sensor 206 for measuring the vertical distance between the depth sensor 206 and the sea surface, as indicated by the elevation measured by the GPS receivers 204A, 204B. By measuring the depths of the various seismic source elements 104, the vertical distances between the seismic source elements and the sea surface can be determined such that variations in such vertical distances between the seismic source elements can be determined. The determined vertical distances represent vertical positions of the seismic source elements that can be used for determining the geometric shape of the seismic source elements.

Various different cases are discussed below. In a first general case, an array of seismic source elements can be focused in a non-vertical direction, given by a vector x=[αβγ)]^{T}. The vector x represents the direction of the ray (path) toward which the seismic energy is focused by the seismic source. For example, if the seismic energy is focused downwardly in a vertical direction, then x would have value [0,0,1]. If the seismic energy is focused along a 450° angle, then x would have value [0,1,1].

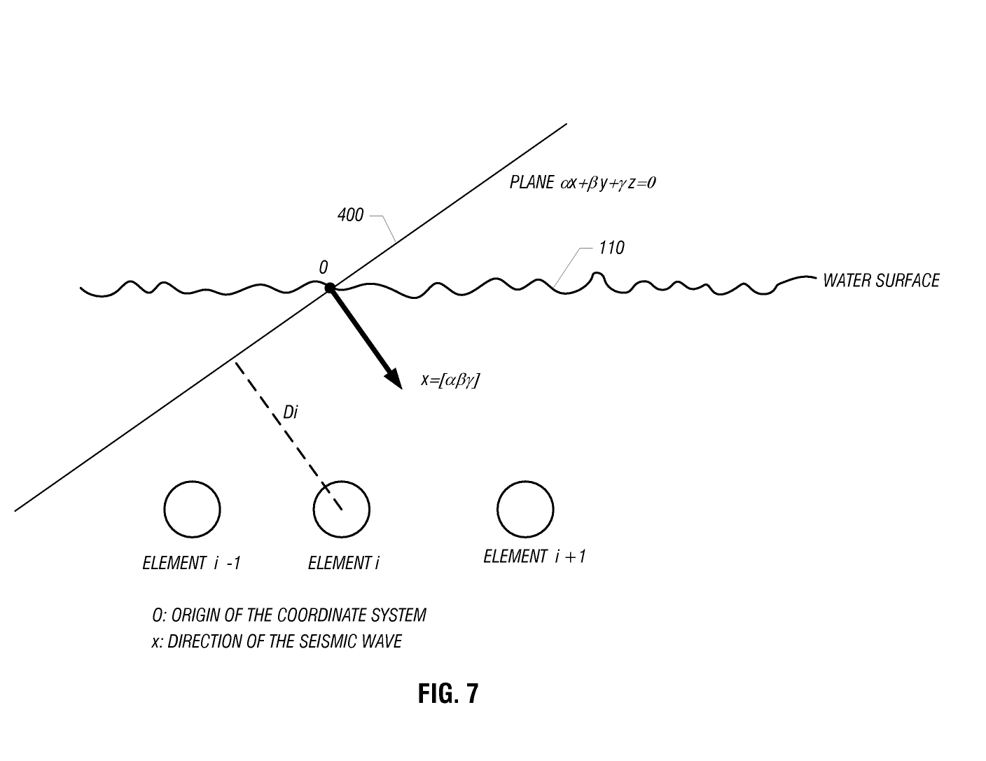

To control timings of the seismic source elements i, i=1 to N (where N represents the number of source elements in the array), the activation times of the seismic source elements are shifted (e.g., delayed) from a target activation time (or multiple corresponding target activation times of the source elements) by a calculated amount based on distances Dᵢ (see FIG. 7). In one embodiment, activation of the i^{th} seismic source element in the array is delayed by Dᵢ/c, where c is the sound velocity in the body of water, and where Dᵢ . is the distance from element i, with coordinate (xᵢ,yᵢ, zᵢ), to a plane 400 (FIG. 7) perpendicular to the vector x, given by αxᵢ+βyzᵢ+yzᵢ₌0. The distance Dᵢ is calculated as follows:

$${D}_{i} = \frac{\vert α {x}_{i} + β {y}_{i} + γ {z}_{i} \vert}{\sqrt{{α}^{2} + {β}^{2} + {γ}^{2}}} .$$

The time shift Dᵢ/c represents a shift from an activation time if the source element i were to be focused in the vertical direction. The distance Dᵢis not a constant value, but a variable value computed from the measured array geometry, obtained right before each shot. The measured array geometry allows for computation of the actual three-dimensional position (xᵢ, yᵢ, zᵢ) before activation.

If the array of seismic source elements has the nominal geometric shape, then the time shift Dᵢ/c would be a constant for each seismic sensing element i. However, if the array of seismic source elements deviates from the nominal geometric shape, then Dᵢ/c would specify non-zero time shifts for at least some of the source elements i to compensate for the variation.

In this manner, even if the sea environment were to cause the three-dimensional geometric shape of the array to deviate from a nominal geometry of the array differently between shots, adjustment of timings of the seismic source elements of the array allow for such deviations to be accounted for such that the source signature at the far field receiver remains consistent.

The above first case discusses a technique in which a three-dimensional shape of seismic source elements of an array can be determined for the purpose of adjusting timings of the seismic source elements. In an alternative embodiment, instead of measuring the three-dimensional geometric shape, information from depth sensors (such as those depicted in FIG. 4) associated with the seismic source elements can be used instead for controlling the timings of the seismic source elements.

In a second case, it is assumed that, in the nominal geometry of the array, all the seismic source elements of the array are at the same elevation. It is also assumed that the desired source signature is focused toward the vertical direction. If all the array source seismic elements are truly at the same elevation, then activating the seismic source elements simultaneously will result in a target source signature. However, in reality, the array seismic source elements will not be at the same elevation due to the sea environment. Let Δeᵢ be the difference between the elevation of the i^{th} seismic source element and the highest elevation of all the seismic source elements. In other words, the highest elevation from among all of the seismic source elements is first determined, with the differences between elevations of the remaining seismic source elements to this highest elevation seismic source elements determined. Based on the differences Δeᵢ, where i=1 to N, where N is the number of seismic source elements in the array, the firing time of the i^{th} seismic source element is to be delayed by Δeᵢ/c, where c is the sound velocity in the body of water. This time shift will counteract the errors in elevations of the seismic source elements, such that the emitted signals from the seismic source elements can be focused toward the vertical direction.

The elevation of each of the seismic source elements can be measured by the GPS receiver 204 (FIG. 4) mounted on the buoy 202, in combination with the depth sensors 206 in the seismic source elements 200. Basically, the GPS receiver 204 at the buoy 202 provides the elevation of the sea surface, whereas the depth sensors 206 measure the depth from the sea surface.

In another case in which just depth information of the seismic source elements is used instead of the determined three-dimensional geometric shape of the first case, it is assumed that, in a nominal geometry, the array of seismic source elements includes elements at different depths. In this second case, before the adjustment discussed for the first case can be applied, the following firing time shift is first applied to account for differences in depths of the seismic source elements in the array in the nominal geometry.

Let Δdᵢ be the difference between the depth of the i^{th} seismic source element and the depth of the highest elevation seismic source element in the nominal geometry of the array. Next, the firing time of the i^{th} seismic source element is calculated to be delayed by Δdᵢ/c to obtain the highest peak pressure at the vertical direction.

However, due to the sea environment, the depth difference Δd₁ for the i^{th} seismic source element will not always be at the nominal value. To account for variations due to the sea environment, the computation according to the second case is performed, with time shifts Δeᵢ/c, i=1 to N, calculated for the N seismic source elements.

Note that the adjustment according to Δdᵢ/c is performed just once to account for the different depths of seismic source elements in the nominal geometry. However, the adjustment according to Δeᵢ/c is performed prior to each shot since the depths can vary from shot to shot. In this case, two time adjustments are performed for each source element i: Δdᵢ/c and Δeᵢ/c.

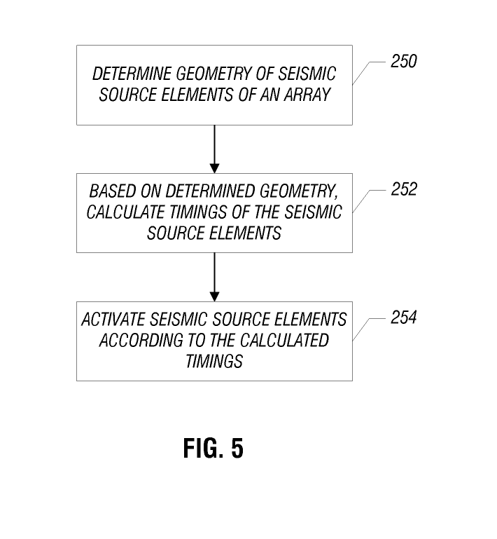

Generally, a process of controlling activation of seismic source elements of an array is depicted in FIG. 5. First, the geometry of the seismic source elements of an array is determined (at 250). The determined geometry can be a three-dimensional geometry determined as discussed above. Alternatively, the geometry of the seismic source elements of the array can refer to the depths of the seismic source elements as determined using the GPS receiver and depth sensors as depicted in FIG. 4, for example.

Based on the determined geometry, timings of the seismic source elements are calculated (at 252). The calculated timings can refer to shifts (e.g., delays) of the activation times from at least one target activation time.

Next, the seismic source elements are activated (at 254) according to the calculated timings. The calculated timings allow for the system to achieve a consistent source signature at a far-field seismic receiver. In this manner, a seismic surveying system can be made to be more tolerate to the sea environment, which can be changing due to various factors, including weather conditions, sea currents, so forth. By basing the activation times in accordance with real-time position measurements (occurring right before each activation of the seismic source), accuracy is enhanced.

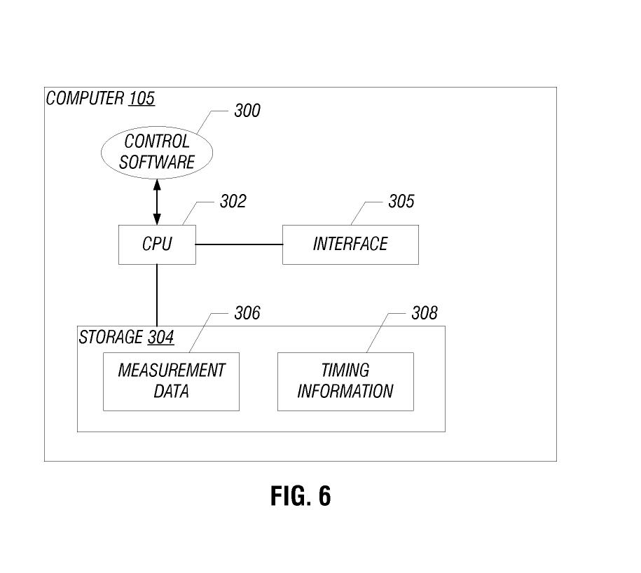

The control of the seismic source elements of a seismic source can be performed by the controller 105 (e.g., computer) on the sea vessel 100 (FIG. 1). For example, as depicted in FIG. 6, the controller 105, which can be implemented as a computer, includes control software 300 that is executable on one or more central processing units (CPUs) 302. The control software 300 is able to receive measurement data associated with the seismic source elements 200 in an array, including data from the GPS receiver 204 and depth sensors, and data associated with the optical or acoustic ranging mechanism discussed above. Based on the measurement data, the control software 300 can determine the geometry of the array of seismic source elements. According to the geometric shape of the seismic source elements of the array, the control software 300 can calculate the timings associated with the seismic source elements of the array such that a target source signature can be achieved.

The CPU(s) 302 is (are) connected to a storage 304 and a communications interface 305 to communicate to a remote network, such as a network connected to the string 102 of seismic sources 104 (FIG. 1). The storage 304 contains measurement data 306 (which includes measurement data noted above), as well as timing information 308 calculated for activating the seismic source elements of each array. The control software 300 can communicate activation commands, such as firing commands, through the communications interface 305 to the seismic source elements 200.

Instructions of the control software 300 are loaded for execution on a processor, such as the one or more CPUs 302. The processor includes microprocessors, microcontrollers, processor modules or subsystems (including one or more microprocessors or microcontrollers), or other control or computing devices. A “processor” can refer to a single component or to plural components.

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

While the invention has been disclosed with respect to a limited number of embodiments, those skilled in the art, having the benefit of this disclosure, will appreciate numerous modifications and variations therefrom. It is intended that the appended claims cover such modifications and variations as fall within the true spirit and scope of the invention.

What is claimed is:

1. A method of controlling a seismic source having plural seismic source elements, comprising:
determining a three-dimensional geometric shape of the plural seismic source elements; and
adjusting timings of activation of the plural seismic source elements according to the determined three-dimensional geometric shape.

2. The method of claim 1, wherein adjusting the timings of activation of the plural seismic source elements comprises:
calculating time shifts of at least some of the plural seismic source elements from at least one target activation time, wherein the calculated time shifts are according to the determined three-dimensional geometric shape of the plural seismic source elements.

3. The method of claim 1, wherein determining the three-dimensional geometric shape of the plural seismic source elements comprises using an optical mechanism.

4. The method of claim 3, wherein determining the three-dimensional geometric shape is further based on depth information of the plural seismic source elements.

5. The method of claim 4, further comprising receiving the depth information of the plural seismic source elements from depth sensors associated with the plural seismic source elements.

6. The method of claim 3, wherein determining the three-dimensional geometric shape using the optical mechanism comprises emitting light from plural light sources, wherein the light from the plural light sources are reflected by the plural seismic source elements.

7. The method of claim 3, wherein determining the three-dimensional geometric shape using the optical mechanism comprises measuring, using cameras, direct light from light sources associated with the seismic sensing elements.

8. The method of claim 1, wherein determining the three-dimensional geometric shape of the plural seismic source elements is based on an acoustic technique.

9. The method of claim 1, further comprising activating the plural seismic source elements according to the adjusted timings to achieve a target source signature.

10. The method of claim 9, wherein achieving the target source signature comprises focusing signals of the seismic source towards a predetermined direction.

11. The method of claim 1, wherein the plural seismic source elements has a nominal geometric shape, and wherein adjusting the timings of activation of the plural seismic source elements is based on deviation of the plural seismic source elements from the nominal geometric shape.

12. The method of claim 11, wherein the nominal geometric shape assumes that all seismic source elements of the seismic source are at the same elevation.

13. The method of claim 11, wherein in the nominal geometric shape the seismic source elements of the seismic source are at different depths.

14. The method of claim 13, further comprising:
adjusting timings of activation of the plural seismic source elements to account for the different depths of the seismic source elements in the nominal geometric shape, wherein adjusting timings to account for the different depths of the seismic source elements is in addition to adjusting timings according to the determined three-dimensional geometric shape.

15. The method of claim 1, wherein the seismic source is focused to a predetermined direction, wherein adjusting the timings of activation of the plural seismic source elements is according to distances from respective seismic source elements to a plane that is perpendicular to the predetermined direction.

16. The method of claim 15, wherein the predetermined direction is represented as x, and wherein the adjusted timings include timing shifts Dᵢ/c, where Dᵢ is the distance of seismic source element i, i=1 to N, to the plane, N being a number of the seismic source elements in the seismic source, and c being a velocity of sound in a body of water in which the seismic source is located.

17. The method of claim 1, further comprising activating the seismic source a plurality of times, wherein the determining and adjusting are repeated prior to each activation of the seismic source.

18. An article comprising at least one computer-readable storage medium containing instructions that when executed cause a computer to:
determine a three-dimensional geometric shape of an array of seismic source elements in a seismic source; and
adjust timings of activation of the plural seismic source elements according to the determined three-dimensional geometric shape.

19. The article of claim 18, wherein determining the three-dimensional geometric shape of the plural seismic source elements is based on using an optical mechanism that involves emitting light beams towards the seismic source elements and receiving reflected light in response to the light beams.

20. The article of claim 18, wherein the instructions when executed cause the computer to:
cause activation of the seismic source a plurality of times, wherein the determining and adjusting are performed prior to each activation of the seismic source.

21. The article of claim 18, wherein adjusting timings of the plural seismic source elements comprises shifting activation times of the corresponding plural seismic source elements from at least one target activation time.

22. The article of claim 21, wherein the instructions when executed cause the computer to:
calculate the shifting of the activation times based on determined distances between corresponding seismic source elements and a plane that is perpendicular to a predetermined direction to which the seismic source is focused.

23. A system to perform a seismic survey operation, comprising:
a seismic source having an array of seismic source elements; and
a controller to:
determine a three-dimensional geometric shape of the array of seismic source elements, and
calculate timings of activation of the plural seismic source elements according to the determined three-dimensional geometric shape.

24. The system of claim 23, wherein the controller is configured to activate the plural seismic source elements according to the calculated timings, wherein the calculated timings indicate timing shifts from at least one target activation time associated with a nominal geometric shape of the array.

25. A method of controlling a seismic source having plural seismic source elements, comprising:
providing a global positioning system (GPS) receiver on a floater at a sea surface;
providing depth sensors associated with corresponding plural seismic source elements of the seismic source;
determining depths of the plural seismic source elements based on output of the GPS receiver and the depth sensors; and
adjusting activation timings of the plural seismic source elements according to the determined depths of the seismic source elements.
